(19) United States
(12) Patent Application Publication
(10) Pub. No.: US 2016/0342701 A1
(43) Pub. Date: Nov. 24, 2016

(54) APPARATUS AND SERVER FOR CONSTRUCTING STREET LIGHT MANAGEMENT DATABASE, AND CONTROLLING METHOD THEREFOR

(71) Applicant: KMW INC., Hwaseong (KR)

(72) Inventors: Seok Sung, Gunpo (KR); Myeong-Kyu Ryu, Yongin (KR); Young-Jun Kim, Suwon (KR); Jae-Woo Choi, Incheon (KR); Woo-Charles Kim, Seoul (KR)

(21) Appl. No.: 15/227,322

(22) Filed: Aug. 3, 2016

Related U.S. Application Data
(63) Continuation of application No. PCT/KR2015/001273, filed on Feb. 9, 2015.

(30) Foreign Application Priority Data
Feb. 7, 2014 (KR) 10-2014-0014195

(51) Int. Cl. G06F 17/30; G06K 7/10; H04W 4/02; H05B 37/02

(52) U.S. Cl. CPC G06F 17/30879; H05B 37/0272; G06F 17/30241; G06F 17/3087; G06F 17/30997; G06K 7/10861; H04W 4/021

(57) ABSTRACT

Disclosed is a method for constructing a street light management database, comprising the steps of: by a portable terminal, photographing and recognizing lamp identification information of a street light; by the portable terminal, displaying a screen for receiving lighting pole information of the street light and receiving the lighting pole information in accordance with a user operation; and by the portable terminal, transmitting the lighting pole information to a server after matching the lighting pole information with the lamp identification information.

### CROSS REFERENCE TO RELATED APPLICATIONS

This application is a continuation of International Application No. PCT/KR2015/001273 filed on Feb. 9, 2015, which claims priority to Korean Application No. 10-2014-0014195 filed on Feb. 7, 2014, which applications are incorporated herein by reference.

### TECHNICAL FIELD

The present invention relates to street light management, and more particularly, to an apparatus and server for building street light management database according to installation of a street light, and a control method thereof.

### BACKGROUND ART

With development of technologies, technology for automating the management of street lights to efficiently manage the street lights has been developed.

An example of typical street light management technology is disclosed in Korean Laid-open Patent Publication No. 2005-0003165 (Title; “Method for Controlling the Streetlamp Used of Computer Bothway Communication and thereof System”, Inventors; Cho Jeong Seop and two others, Applicant; Cho Jeong Seop, Laid-open Date; Jan. 10, 2005). The street light management apparatus disclosed in the Korean Laid-open Patent Publication No. 2005-0003165 is to remotely operate street lights, to effectively monitor the lighting conditions of roads by checking the street lights visually through pictures and checking the street lights through state signals, and to database a history to perform fault management and maintenance management, thereby comprehensively managing repair materials, equipment, and manpower.

As disclosed in the Korean Laid-open Patent Publication No. 2005-0003165, many technologies for managing street lights installed and registered in a street light control server have been developed.

However, technology for automatically registering and managing an installed street light is not yet developed. Accordingly, when an engineer installs a street light, the engineer should himself/herself map an unique ID of the pole of the street light with a server to register the street light in the server. In other words, the engineer needs to check the unique ID of the pole of the installed street light, and then input the unique ID to the server in order to register and manage the installed street light. However, this typical method deteriorates the efficiency of registration and management of street lights, and in some cases, it causes a problem due to an engineer's mistake.

### SUMMARY

An aspect of the present invention provides an apparatus and server for building street light management database to easily and automatically register an unique identifier (ID) of the pole of a street light in a street light control server, and a control method thereof.

Another aspect of the present invention provides an apparatus and server for building street light management database to easily and automatically register and database various information about a street light, such as position information of the street light, installation information of the street light, information about an engineer who registers the street light, registration date and time information, etc., in a street light control server, together with an unique identifier (ID) of the pole of the street light, and a method of controlling the apparatus and the server.

In accordance with an aspect of exemplary embodiments of the present invention, there is provided a method of building street light management database including: at a mobile terminal, photographing lamp identification information of a street light to recognize the lamp identification information; at the mobile terminal, displaying a screen for receiving pole information of the street light, and receiving the pole information according to a user's manipulation; and at the mobile terminal, matching the pole information with the lamp identification information, and transmitting the pole information and the lamp identification information to a server.

In accordance with another aspect of exemplary embodiments of the present invention, there is provided an apparatus for building street light management database including: an input unit configured to receive a user's manipulation; a display unit configured to display an execution image, an operating state, and a menu state of an application program; an imaging unit configured to photograph a subject; a wireless communication unit configured to transmit and receive a radio signal; and a controller configured to photograph lamp identification information of a street light through the imaging unit, to recognize the lamp identification information, to display a screen for receiving pole information of the street light on the display unit, to receive the pole information through the input unit, to match the pole information with the lamp identification information, and to transmit the pole information and the lamp identification information to a server through the wireless communication unit.

In accordance with still another aspect of exemplary embodiments of the present invention, there is provided a street light control server for building street light management database including: database; a communication module configured to transmit and receive a radio signal; and a street light control apparatus configured to receive lamp identification information of a street light and pole information matching with the lamp identification information from a mobile terminal through the communication module, and to store the lamp identification information in correspondence to the pole information in the database.

### BRIEF DESCRIPTION OF DRAWINGS

The above and other aspects, features, and advantages of the present invention will be more apparent from the following detailed description taken in conjunction with the accompanying drawings, in which:

FIG. 1 shows an example of system for building street light management database, according to an embodiment of the present disclosure;

FIG. 2 is a block configuration diagram of a mobile terminal for building street light management database, according to an embodiment of the present disclosure;

FIG. 3 is a flowchart illustrating operation for building street light management database, according to an embodiment of the present disclosure;

FIG. 4 is a flowchart illustrating operation of a mobile terminal for building street light management database, according to an embodiment of the present disclosure; and

FIG. 5 is a flowchart illustrating operation of a street light control server for building street light management database, according to an embodiment of the present disclosure.

### DETAILED DESCRIPTION

Hereinafter, preferred embodiments of the present disclosure will be described in detail with reference to the accompanying drawings. In the following description, names and specific details of components, etc. are set forth such as street light installation information, engineer information, etc., in order to help a thorough understanding of the present disclosure. However, it will be apparent to one skilled in the art that these specific details can be modified or changed within the scope of the present disclosure.

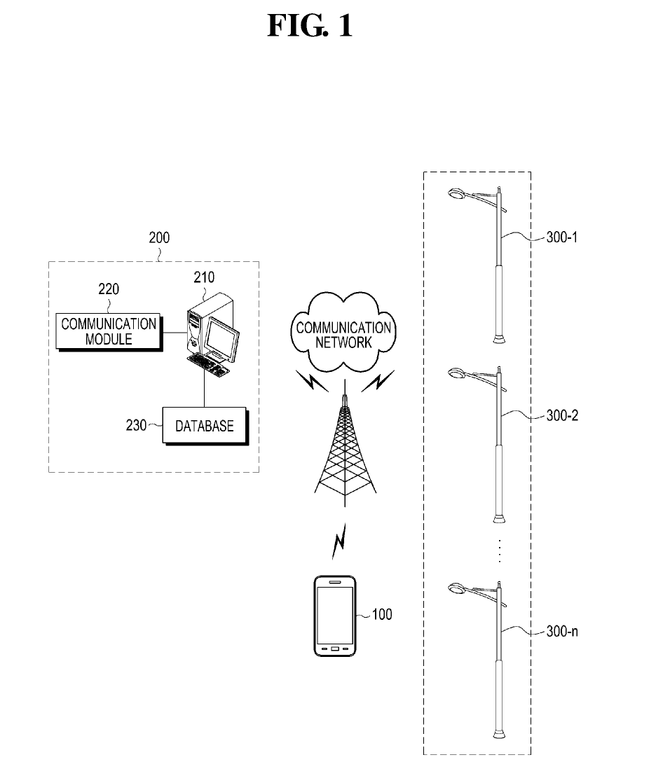

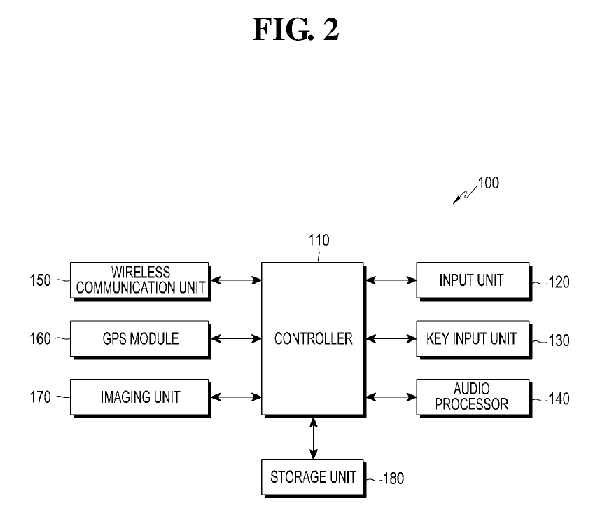

FIG. 1 shows an example of system for building street light management database, according to an embodiment of the present disclosure, and FIG. 2 is a block configuration diagram of a mobile terminal for building street light management database, according to an embodiment of the present disclosure. Referring to FIG. 1, system for building street light management database may include a mobile terminal 100, a street light control server 200, and one or more street lights 300-1, 300-2, . . . , 300-n. Generally, each of the street lights 300-1, 300-2, . . . , 300-n may include a lamp and a pole for supporting the lamp.

Referring to FIG. 2, the mobile terminal 100 may include a controller 110, a touch screen 120, a key input unit 130, an audio processor 140, a wireless communication unit 150, a Global Positioning System (GPS) module 160, an imaging unit 170, and a storage unit 180.

The touch screen (also referred to as an input unit or a display unit) 120 may be configured with a display panel (not shown) to perform a function of displaying output information output from the mobile terminal 100, and an input sensing panel (not shown) to receive various kinds of inputs by a user. The display panel may be implemented as a Liquid Crystal Display (LCD) screen, or an Organic Light Emitting Diodes (OLED; for example, Passive Matrix OLED (PMOLED) or Active Matrix OLED (AMOLED)) screen. Also, the display panel may be structurally integrated into the input sensing panel. The display panel may display various screens according to various operation states, menu states, application execution, a service, etc. of the mobile terminal 100.

Meanwhile, the input sensing panel may be implemented as at least one panel capable of sensing a user's various inputs, for example, a single- or multi-touch input, a drag input, a writing input, a drawing input, etc., using various kinds of objects, such as a finger, an electronic pen (also, simply referred to as a “pen”), etc. For example, the input sensing panel may be implemented using a single panel capable of sensing both inputs by a finger and inputs by an electronic pen, or two panels of a hand sensing panel (not shown) capable of sensing inputs by a finger and a pen sensing panel (not shown) capable of sensing inputs by an electronic pen.

The key input unit 130 may include a plurality of keys mechanically installed on the outer housing of the mobile terminal 100 to allow a user to execute a plurality of operations, thereby receiving a user's manipulations. The keys may be side keys or a touch panel provided separately. Also, the key input unit 130 may include a button key to turn on/off the mobile terminal 100, a home key to return to a home screen of the mobile terminal 100, etc.

The audio processor 140 may include at least one of a speaker for outputting audio signals of the mobile terminal 100 and a microphone for collecting audio signals. The audio processor 140 may include the speaker, the microphone, voice codec for processing audio signals input/output through the speaker and the microphone, etc. When a phone call is made according to a mobile communication function, the audio processor 140 may input a user's voice or output audible sound to the user. Also, the audio processor 140 may output tones corresponding to various kinds of operations, sound corresponding to various kinds of digital audio contents, and sound corresponding to video contents.

The wireless communication unit 150 may perform wireless signal processing operation for wireless communications with an external device, such as a server, a mobile communication terminal, etc. The wireless communication unit 150 may include an antenna, an RF unit, and a MODEM. The RF unit may include a RF transmitter to up-convert and amplify the frequency of a signal to be transmitted, and a RF receiver to low-noise amplify and down-convert a received signal. The MODEM may include a transmitter to encode and modulate a signal to be transmitted, and a receiver to demodulate and decode a signal received by the RF unit. Also, the wireless communication unit 150 may include a Wireless Local Area Network (WLAN) module or a module for short-range communication, such as Wi-Fi Direct, Near Field Communication (NFC), Bluetooth, etc., to connect to the wireless Internet at a place where a Wireless Access Point (WAP) is installed or to perform short-range communications with peripheral devices in a wireless fashion.

The GPS module 160 may receive radio waves from a plurality of earth-orbiting GPS satellites (not shown), and calculate a position of the mobile terminal 100 using a time of arrival taken for the radio waves from the GPS satellites to arrive at the mobile terminal 100.

The imaging unit 170 may photograph a subject to create a still image or a moving image under the control of the controller 110. The imaging unit 170 may include at least one of a first camera 151 and a second camera 152.

The storage unit 180 may store signals or data that are input/output to correspond to operations of the touch screen 120, the key input unit 130, the audio processor 140, the wireless communication unit 150, the GPS module 160, and the imaging unit 170, under the control of the controller 110. Also, the storage unit 180 may store control programs and applications for controlling the mobile terminal 100 or the controller 110.

The term “storage unit” indicates an arbitrary data storage device, such as the storage unit 180, ROM (not shown) and RAM (not shown) in the controller 110, a memory card (for example, a Secure Digital (SD) card or a memory stick) (not shown) installed in the mobile terminal 100, and the like. The storage unit may include a non-volatile memory, a volatile memory, a hard disk drive (HDD), and a solid state drive (SSD).

The controller 110 may include a Central Processing Unit (CPU) (not shown), ROM (not shown) that stores control programs for controlling the mobile terminal 100, and RAM (not shown) that stores signals/data received from an external device or tasks being executed by the mobile terminal 100. The CPU may be a single-core, a dual-core, a triple-core, or a quad-core. The CPU, the ROM, and the RAM may be connected to each other through internal buses.

Also, the controller 110 may control overall operations of the individual components.

Also, the controller 110 may photograph lamp identification information of a street light through the imaging unit 170 to recognize the lamp identification information, display a screen for receiving pole information of the street light on the touch screen 120, receive the pole information through the touch screen 120, the key input unit 130, or the microphone of the audio processor 140 (the touch screen 120, the key input unit 130, or the microphone of the audio processor 140 can be considered as an input unit (not shown)), match the pole information with the lamp identification information, and transmit the pole information and the lamp identification information to a server through the wireless communication unit 150, according to the characteristics of operation for building street light management database of the present disclosure. The operation for building the street light management database according to an embodiment of the present disclosure will be described in detail, as follows.

The street light control server 200 (also referred to as a server) may include a street light control apparatus 210, a communication module 220, and database 230. The server 200 may communicate or interwork with the mobile terminal 100 and/or the street lights 300-1, 300-2, . . . , 300-n through a network to perform tasks, wherein the network may be one of a LAN, a WLAN, a Wide Area Network (WAN), the Internet, and a Small Area Network (SAN).

The street light control apparatus 210 of the street light control server 200 may be connected to the street lights 300-1, 300-2, . . . , 300-n through the communication module 220. That is, the street light control apparatus 210 may generate control signals for controlling the street lights 300-1, 300-2, . . . , 300-n, and transmit the control signals to the street lights 300-1, 300-2, . . . , 300-n through the communication module 220, thereby turning on/off the street lights 300-1, 300-2, . . . , 300-n.

Also, according to an embodiment of the present disclosure, the street light control apparatus 210 may be connected to the mobile terminal 100 through the communication module 220 for transmitting/receiving radio signals, to receive lamp identification information of a street light and pole information matching with the lamp identification information from the mobile terminal 100, and to store the lamp identification information in correspondence to the pole information in the database 230. Operation for building the street light management database of the street light control server 200, according to an embodiment of the present disclosure, will be described in detail, as follows.

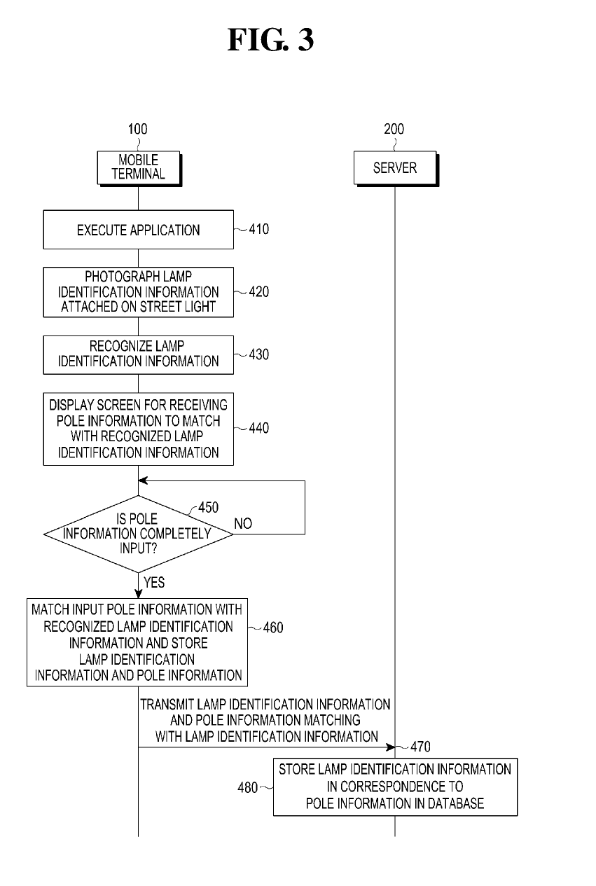

FIG. 3 is a flowchart illustrating operation for building street light management database, according to an embodiment of the present disclosure. Referring to FIG. 3, in operation 410, the mobile terminal 100 may execute an application for building street light management database, according to a user's manipulation, wherein the user can be also referred to as an engineer.

Then, in operation 420, the mobile terminal 100 may photograph lamp identification information attached on a street light, according to the user's manipulation. Successively, in operation 430, the mobile terminal 100 may recognize the lamp identification information. The lamp identification information may include a lamp serial number, a Media Access Control (MAC) address for a control module, a channel for wireless communication, and a Personal Area Network (PAN) ID. Also, the lamp identification information may be in the format of, for example, a barcode or a Quick Response (QR) code, and the barcode or the QR code may be recognized based on well-known barcode recognition technology. For example, lamp identification information stored in the QR code which is a kind of a matrix-type 2Dimensional (2D) code may be recognized by a program or application stored in advance in the mobile terminal 100 for recognizing QR codes.

Thereafter, in operation 440, the mobile terminal 100 may display a screen for receiving pole information to match with the recognized lamp identification information. The pole information may be an ID assigned to identify each pole, and may be used to identify a street light.

Then, in operation 450, the mobile terminal 100 may determine whether pole information is completely input. The pole information may be input by a user who checked information written on a sticker attached on the street light. Also, the pole information may be automatically input when the user photographs pole information of the street light through a camera of the mobile terminal 100, and the mobile terminal 100 recognizes the pole information using the well-known content recognition technology. If the mobile terminal 100 determines in operation 450 that pole information is completely input, the process may proceed to operation 460, and if the mobile terminal 100 determines in operation 450 that pole information is not completely input, the mobile terminal 100 may again perform operation 450.

Successively, in operation 460, the mobile terminal 100 may match the pole information with the recognized lamp identification information, and store the lamp identification information and the pole information matching with the lamp identification information. Then, in operation 470, the mobile terminal 100 may transmit the lamp identification information and the pole information matching with the lamp identification information to the street light control server 200. Then, in operation 480, the street light control server 200 may store the lamp identification information in correspondence to the pole information in database.

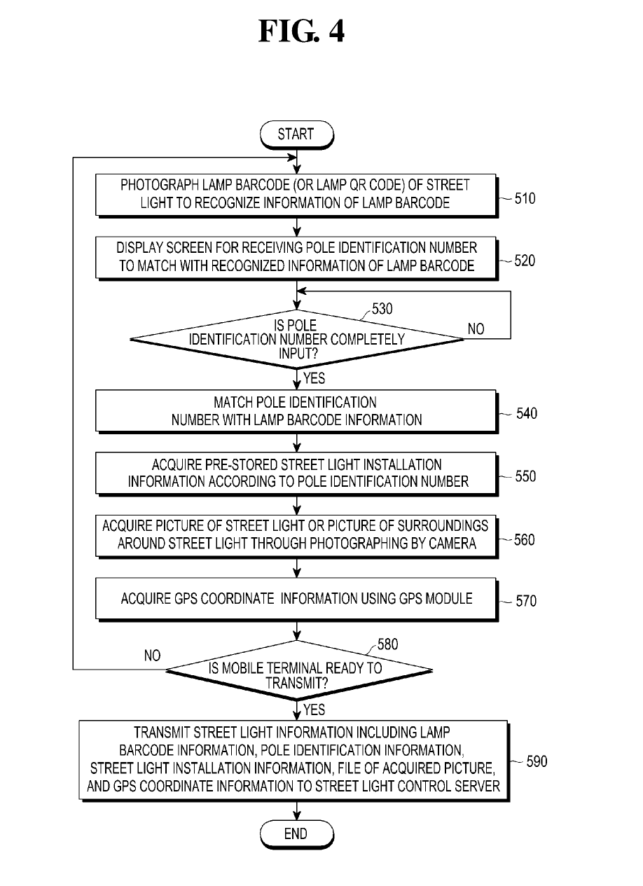

FIG. 4 is a flowchart illustrating operation of a mobile terminal for building street light management database, according to an embodiment of the present disclosure. Referring to FIG. 4, operation of a mobile terminal will be described in detail, as follows. First, in operation 510, a lamp barcode (or a lamp QR code; hereinafter, the lamp barcode will be described as an example) of a street light, the lamp barcode being lamp identification information of the street light, may be photographed to recognize lamp barcode information.

Then, in operation 520, a screen for receiving pole information (that is, a pole identification number) to match with the recognized lamp barcode information may be displayed. The screen may be set to automatically display the recognized lamp barcode information in addition to the pole identification number when the mobile terminal 100 is manufactured or according to the user's setting, and the screen may be set to be displayed by receiving information (GPS coordinate information, street light installation information, etc.) which will be described later.

Then, in operation 530, it may be determined whether the pole identification information is completely input. If it is determined in operation 530 that the pole identification information is completely input, the process may proceed to operation 540, and if it is determined in operation 530 that the pole identification information is not completely input, operation 530 may be again performed.

Successively, in operation 540, the pole identification number may be matched with the lamp barcode information. Then, in operation 550, pre-stored street light installation information may be automatically acquired according to the pole identification number. The street light installation information may be a date on which the street light is installed, the name of an engineer who installs the street light, significant notes, etc.

Then, in operation 560, a camera may photograph the street light or surroundings around the street light according to the user's manipulation to acquire a picture of the street light or a picture of the surroundings around the street light. Next, in operation 570, position information (that is, GPS coordinate information) of the mobile terminal may be acquired using a GPS module of the mobile terminal in order to collect position information of the street light, under the assumption that the mobile terminal is located near the street light.

Then, in operation 580, it may be determined whether the mobile terminal is ready to transmit street light information including the above-described information. If it is determined in operation 580 that the mobile terminal is ready to transmit the street light information, the process may proceed to operation 590, and if it is determined in operation 580 that the mobile terminal is not ready to transmit the street light information, the process may return to operation 510.

Thereafter, in operation 590, the street light information including the lamp barcode information, the pole identification information, the street light installation information, a file of the acquired picture, and the GPS coordinate information may be transmitted to a street light control server.

The street light information may further include engineer (or referred to as user) information, installation date information, and installation time information. The engineer information may be user information stored in advance in the mobile terminal and acquired by the mobile terminal, or information input according to a user's manipulation. The installation date information may be information input according to the user's manipulation, or information acquired by the mobile terminal from the current date checked by the mobile terminal. Also, the installation time information may be information input according to the user's manipulation, or information acquired by the mobile terminal by checking a time at which a command for transmitting the street light information to the server is input.

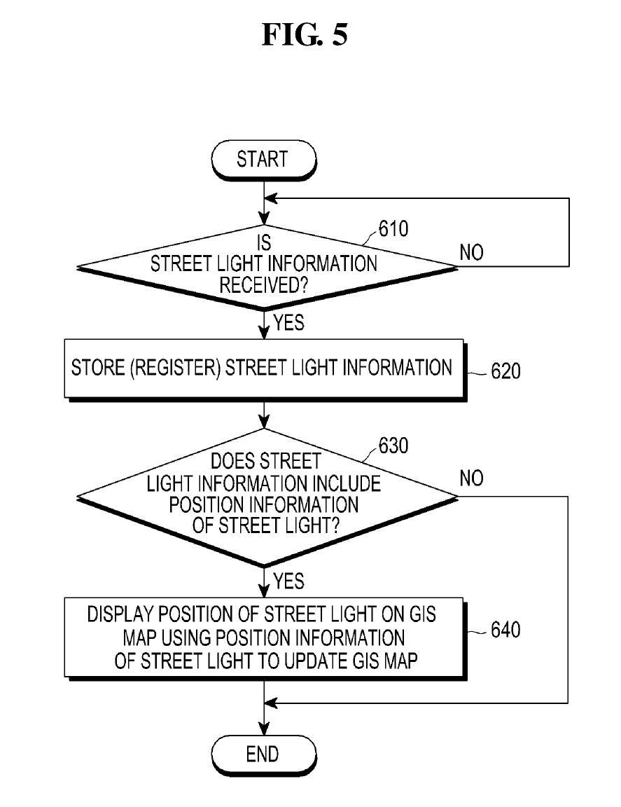

FIG. 5 is a flowchart illustrating operation of a street light control server for building street light management database, according to an embodiment of the present disclosure. Operation of the street light control server will be described with reference to FIG. 5, as follows. First, in operation 610, it may be determined whether street light information including lamp barcode information and a pole identification number matching with the lamp barcode information is received from a mobile terminal. If it is determined in operation 610 that the street light information is received, the process may proceed to operation 620, and if it is determined in operation 610 that no street light information is received, operation 610 may be again performed.

Then, in operation 620, the received street light information may be stored, that is, registered and databased. The street light information may further include street light installation information (an installation date of the street light, an engineer who installs the street light, significant notes, etc.), a picture file, and GPS coordinate information. Additionally, the street light information may include engineer (also referred to as user) information, installation date information, and installation time information.

Then, in operation 630, it may be determined whether the street light information includes position information of the street light. If it is determined in operation 630 that the street light information includes position information of the street light, the process may proceed to operation 640, and if it is determined in operation 630 that the street light information includes no position information of the street light, the operation may terminate.

Thereafter, in operation 640, the position of the street light may be displayed on a Geographic Information System (GIS) map using the position information of the street light to thus update the GIS map. The street light control server may enable the user to enlarge or reduce the GIS map according to a predetermined manipulation to check the street light information displayed on the GIS map. Also, the user can check the state of the corresponding street light and the street light information by touching the position of the street light displayed on the GIS map or approaching a mouse cursor or the like close to the position of the street light.

The configuration and operations of the apparatus and server for building street light management database and the control method thereof, according to an embodiment of the present disclosure, have been described. Meanwhile, the above descriptions relate to detailed embodiments, however, the embodiments can be modified or changed within the scope of the present disclosure.

For example, in the above-described embodiment, the database is included in the street light control server, however, a database server may be separately configured to receive and store street light information from the street light control server.

Also, in the above-described embodiment, the street light installation information is stored in advance in the mobile terminal according to the pole identification number, however, a user may check information written on a sticker attached on, for example, the pole of the street light to input the information to the mobile terminal. Also, in the embodiment, the street light installation information may be stored in advance in the mobile terminal or the database of the street light control server according to the pole identification number.

Also, in the embodiment, the position information is acquired using the GPS module, however, the user may input position information.

Also, in the embodiments, the screen for receiving pole information is displayed after the lamp identification information is recognized, however, the lamp identification information may be photographed and the photographed lamp identification information may be recognized after the screen for receiving pole information is displayed.

Also, in the above description with reference to FIG. 4, operations are sequentially performed in the order of acquiring the street light installation information and the picture of surroundings around the street light and acquiring the GPS coordinate information, however, the operations may be performed in a different order or omitted according to settings of the mobile terminal and/or the user's manipulation.

As described above, by using the apparatus and server for building street light management database, and the control method thereof, it is possible to easily and automatically register an unique Identifier (ID) of the pole of a street light in a street light control server. Also, by using the apparatus and server for building street light management database, and the control method thereof, it is possible to easily and automatically register and database various information about the street light, such as position information of the street light, installation information of the street light, information about an engineer who registers the street light, registration date and time information, etc., together with the unique ID of the pole of the street light, in the street light control server.

Embodiments of the present invention may be implemented in the form of hardware, software, or a combination of hardware and software. The software may be stored in a non-volatile memory device such as, for example, a Read-Only Memory (ROM), regardless of whether it is erasable or re-writable, in a memory such as, for example, a Random Access Memory (RAM), a memory chip, and an Integrated Circuit (IC), or in an optically/magnetically recordable and machine-readable storage medium such as, for example, a Compact Disk (CD), a Digital Versatile Disk (DVD), a magnetic disk, and a magnetic tape. A memory that can be included in a mobile terminal is an example of a machine-readable storage medium suitable to store one or more programs, including instructions implementing embodiments of the present invention. Therefore, embodiments of the present invention include programs including codes for implementing the devices and methods as set forth in the appended claims of the specification, and a machine-readable storage medium storing these programs. These programs may be electronically transferred through any media and equivalents thereof, such as communication signals, which are transferred through wired or wireless connections.

What is claimed is:

1. A method of building street light management database, comprising:
at a mobile terminal, photographing lamp identification information of a street light to recognize the lamp identification information;
at the mobile terminal, displaying a screen for receiving pole information of the street light, and receiving the pole information according to a user's manipulation; and
at the mobile terminal, matching the pole information with the lamp identification information, and transmitting the pole information and the lamp identification information to a server.

2. The method of claim 1, comprising acquiring position information of the street light according to position information of the mobile terminal,
wherein the mobile terminal transmits the position information of the street light to the server, when matching the pole information with the lamp identification information and transmitting the pole information and the lamp identification information to the server.

3. The method of claim 1, comprising, at the mobile terminal, photographing a subject to acquire a picture,
wherein the mobile terminal transmits a file of the acquired picture to the server, when matching the pole information with the lamp identification information and transmitting the pole information and the lamp identification information to the server.

4. The method of claim 1, wherein the mobile terminal transmits at least one of street light installation information, engineer information, installation date information, and installation time information to the server, when matching the pole information with the lamp identification information and transmitting the pole information and the lamp identification information to the server.

5. The method of claim 4, wherein the engineer information is user information stored in advance in the mobile terminal and acquired by the mobile terminal, or information input according to the user's manipulation.

6. The method of claim 4, wherein the installation date information is information input according to the user's manipulation, or information acquired by the mobile terminal from the current date checked by the mobile terminal.

7. The method of claim 4, wherein the installation time information is information input according to the user's manipulation, or information acquired by the mobile terminal by checking a time at which a command for transmitting the street light information to the server is input.

8. The method of claim 4, wherein the street light installation information includes information about at least one of an installation date of the street light, an engineer who installs the street light, and significant notes of the street light, the street light installation information being information input according to the user's manipulation or information stored in advance according to the pole information.

9. The method of claim 1, wherein the lamp identification information is a barcode or a Quick Response (QR) code.

10. An apparatus for building street light management database, comprising:
an input unit configured to receive a user's manipulation;
a display unit configured to display an execution image, an operating state, and a menu state of an application program;
an imaging unit configured to photograph a subject;
a wireless communication unit configured to transmit and receive a radio signal; and
a controller configured to photograph lamp identification information of a street light through the imaging unit, to recognize the lamp identification information, to display a screen for receiving pole information of the street light on the display unit, to receive the pole information through the input unit, to match the pole information with the lamp identification information, and to transmit the pole information and the lamp identification information to a server through the wireless communication unit.

11. The apparatus of claim 10, further comprising a Global Positioning System (GPS) module,
wherein the controller detects position information of the apparatus through the GPS module, acquires position information of the street light based on the position information of the apparatus, and transmits the position information of the street light to the server through the wireless communication unit.

12. The apparatus of claim 10, wherein the controller photographs a subject through the imaging unit to acquire a picture, and transmits a file of the acquired picture to the server through the wireless communication unit.

13. The apparatus of claim 10, wherein the controller transmits at least one of installation information of the street light, information about an engineer, installation date information, and installation time information to the server through the wireless communication unit.

14. A street light control server for building street light management database, comprising:
database;
a communication module configured to transmit and receive a radio signal; and
a street light control apparatus configured to receive lamp identification information of a street light and pole information matching with the lamp identification information from a mobile terminal through the communication module, and to store the lamp identification information in correspondence to the pole information in the database.

15. The street light control server of claim 14, wherein the street light management apparatus receives position information of the street light from the mobile terminal through the communication module, and displays a position of the street light on a Geographic Information System (GIS) map based on the position information of the street light.
